(19) United States
(12) Patent Application Publication
(10) Pub. No.: US 2012/0300435 A1
(43) Pub. Date: Nov. 29, 2012

(54) LIGHT FOR A LIFE VEST

(76) Inventor: Christopher Ross Hill, Hampshire (GB)

(21) Appl. No.: 13/480,703

(22) Filed: May 25, 2012

(30) Foreign Application Priority Data
May 26, 2011 (GB) 1108847.3

(51) Int. Cl. B63C 9/11; F21L 4/00; G08B 5/22; F21V 21/00

(52) U.S. Cl. 362/103; 362/431; 362/249.02; 362/190; 340/6.1

(57) ABSTRACT

A light for a life vest comprises a resilient pole, a light source disposed at a first end of the resilient pole and a mount supporting a second end of the resilient pole, the mount configured for securing the light to an inflatable bladder of a life vest such that inflation of the bladder causes the pole to extends outwardly with respect to the surface of the bladder. A test circuit for testing the power level of a battery that powers the light source may also be included.

This application claims priority of UK Application No. 1108847.3 filed May 26, 2011 which is hereby incorporated herein by reference.

### BACKGROUND OF THE INVENTION

The present invention relates to a light for a life vest.

Life vests, also known as life jackets, are a safety garment worn by individuals operating near water. In the event of the individual accidentally entering the water, an inflatable bladder in the life vest is automatically inflated to provide the individual with a buoyancy aid intended to keep the individual afloat in the water until help arrives. The inflation of the bladder is produced by a gas canister within the life vest which is automatically activated when the life vest enters water. The bladder is typically packed in an uninflated state into a protective cover attached to a harness or similar securing means by which a wearer can secure the life vest around his torso. Inflation of the bladder causes the bladder to break out of the cover without the wearer having to open the cover. When inflated, the bladder forms a horse-shoe, ring or similar shape around the wearer's neck so that his head is held above water.

To facilitate rescue of a life vest wearer who is in the water, it is common for a life vest to be provided with a light. The light is positioned on a part of the inflatable bladder that will be above water when the bladder is inflated, and has a power source in the form of a battery, and an operating switch that actuates on contact with water. Hence, when the wearer enters the water, the inflation of the bladder and the illumination of the light both occur automatically. The light makes the life vest and wearer more visible in conditions of poor visibility such as darkness and bad weather.

However, the light can be difficult for rescuers to see as it may be obscured by the wearer's head or by intervening rough waters.

Also, the light will only operate if there is adequate power supplied by the battery. As is well known, battery power tends to drain away over time even if the battery is not used. For operation of electrical items in a wet environment it is important that the components are adequately sealed, so for a life vest light, the light source, the power supply and the connection between the two are typically formed into a water-tight sealed unit. Only the water connections of the water-actuated operating switch are exposed. Hence it is impossible or impractical to replace the battery. Consequently, it is usual to replace the light unit of a life vest on a regular basis to ensure that the light is operational. This is costly and wasteful.

Hence, there is a requirement for improved lights for life vests.

### SUMMARY OF THE INVENTION

Accordingly, a first aspect of the present invention is directed to a light for a life vest comprising: a resilient pole; a light source disposed at a first end of the resilient pole; and a mount supporting a second end of the resilient pole, the mount configured for securing the light to an inflatable bladder of a life vest such that inflation of the bladder causes the pole to extend outwardly with respect to the surface of the bladder. The pole elevates the light source above the water surface and above the wearer's head so that it can be seen more easily by searching rescuers.

The mount may comprise a planar base from which the pole extends substantially orthogonally. Inflation of the bladder positions the planar base flat against the bladder surface, thereby locating the pole in an upright position to elevate the light.

The mount may further comprise a belt attached to the base, the belt being configured to pass around an inflatable bladder of a life vest. The belt may comprise a fastener by which the belt can be secured around an inflatable bladder of a life vest. The fastener may be a press stud or a hook-and-loop fastening.

The light source may comprise one or more light emitting diodes.

The light may further comprise a power source operable to supply electrical power to the light source to illuminate the light source; and a switch operable to connect the power source to the light source when the switch comes into contact with water. Additionally, the light may comprise a power source test circuit operable to indicate an operating state of the power source to a user. This allows the power level remaining in the power source, such as a battery, to be tested so that it can be determined whether the light source is safe for use, or whether it would fail to illuminate and hence should be replaced.

The power source test circuit may comprise a test switch actuable by a user to produce a measurement of a level of electrical power available from the power source; and one or more indicators operable to notify a result of the electrical power level measurement to the user. The one or more indicators may comprise a first indicator that notifies if the power source is able to supply adequate electrical power to illuminate the light source, and a second indicator that notifies if the power source is not able to supply adequate electrical power to illuminate the light source. The one or more indicators may comprise one or more light emitting diodes.

In other embodiments, the light may further comprise a sound source operable to emit an alarm sound. The alarm sound can supplement the emitted light to increase the chances of attracting the attention of rescuers. In an example, the sound source may comprise a loud speaker disposed at the first end of the resilient pole, a signal generator operable to supply a sound signal to the loud speaker, and a switch for activating the signal generator. A speaker positioned at the top of the pole can broadcast the alarm sound more widely, by decreasing attenuation by nearby waves or the head of the life vest wearer. The switch may be a manually operated switch, so that the wearer can turn the alarm sound on and off as desired, independently of the automatic operation of the light source.

A second aspect to the invention is directed to a life vest comprising an inflatable bladder and a light according to the first aspect.

A third aspect of the invention is directed to a light for a life vest comprising: a light source attachable to an inflatable bladder in a life vest; a power source operable to supply electrical power to the light source to illuminate the light source; a switch operable to connect the power source to the light source when the switch comes into contact with water; and a power source test circuit operable to indicate an operating state of the power source to a user. The power source test circuit may comprise a test switch actuable by a user to produce a measurement of a level of electrical power available from the power source; and one or more indicators operable to notify a result of the electrical power level measurement to the user. The one or more indicators may comprise a first indicator that notifies if the power source is able to supply adequate electrical power to illuminate the light source, and a second indicator that notifies if the power source is not able to supply adequate electrical power to illuminate the light source. The one or more indicators may comprise one or more light emitting diodes.

A fourth aspect of the invention is directed to an audio alarm for a life vest, comprising: a resilient pole; a sound source operable to emit an alarm sound disposed at a first end of the resilient pole; and a mount supporting a second end of the resilient pole, the mount configured for securing the audio alarm to an inflatable bladder of a life vest such that inflation of the bladder causes the pole to extend outwardly with respect to the surface of the bladder. The pole elevates the sound source above the water surface and above the wearer's head so that the alarm sound can be detected more easily by searching rescuers.

### BRIEF DESCRIPTION OF THE DRAWINGS

For a better understanding of the invention and to show how the same may be carried into effect reference is now made by way of example to the accompanying drawings in which:

FIG. 1 shows an illustration of a light for a life vest according to an embodiment of the invention;

FIG. 2 shows an illustration of a power unit of the light shown in FIG. 1;

FIG. 3 shows an illustration of an individual wearing a life vest (shown partially) configured to include the light of FIG. 1 with an inflatable bladder of the life vest being uninflated;

FIG. 4 shows the individual and life vest of FIG. 3 after the bladder has been inflated; and

FIG. 5 shows an illustration of part of a light according to another embodiment of the invention; and

FIG. 6 shows an illustration of a power unit suitable for use with the light of FIG. 5.

### DETAILED DESCRIPTION

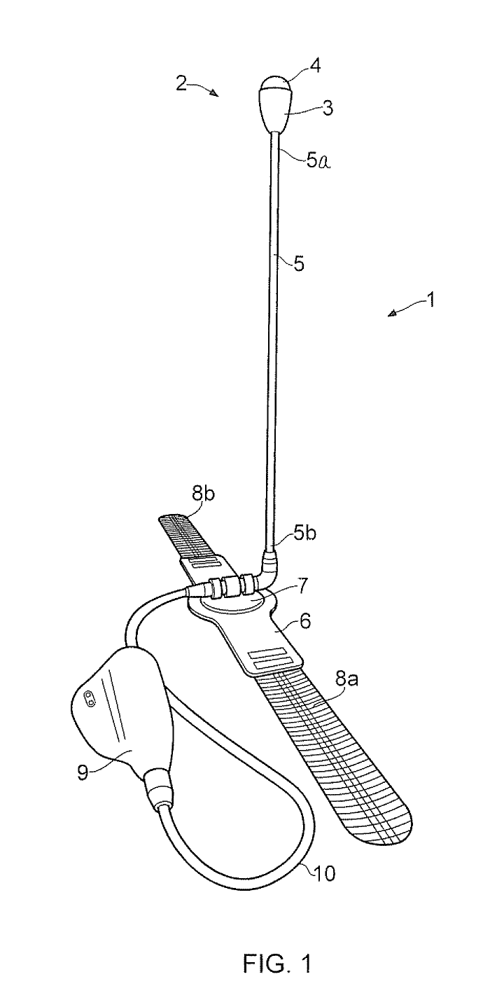

FIG. 1 shows an example of a light for a life vest in accordance with an embodiment of the invention. The light 1 comprises a light source 2, which in this example comprises a light emitting diode (LED) (not shown) held in a watertight housing 3 surmounted by a transparent dome 4 through which illumination from the LED is emitted when the LED is operational. The LED can be configured to operate as a flashing light source or a continuously emitting light source. A flashing light may be preferred as being more easily detected by rescuers. More than one LED could alternatively be used, or an alternative light emitting device such as a bulb.

The light 1 further comprises a resilient pole 5. The light source 2 is mounted on a first, upper, end 5a of the pole 5. The pole may have a length in the range 15 cm to 25 cm, although shorter or longer poles may be used as appropriate.

A mount 6 is also provided. The second, lower, end 5b of the pole 5 is attached to the mount 6. The mount 6 is provided to mount the light to a life vest. It is configured such that when the light is properly mounted onto the inflatable bladder of a life vest, inflation of the life vest causes the pole 5 to extend outwardly from the surface of the inflated bladder. The inflated bladder will be floating on water, so the pole 5 will extend substantially upwardly, and hence will act to elevate the light source 2 up into the air, away from the surface of the water, and preferably above the level of the life vest wearer's head. The light source 2 is thereby made more visible to observing searchers and rescuers.

Some or all of the surface of the pole 5 can be made light-reflective. This will increase visibility of the light to rescuers searching with torches and search-lights.

In the illustrated example, the mount 6 comprises a base 7. The base 7 is planar, and the pole 5 is mounted onto the base such that the pole 5 is substantially orthogonal thereto. As the inflatable bladder of the life vest expands on inflation, the planar base 7 adopts a position in which it lies largely flat against the surface of the bladder that will be uppermost with respect to the water. In this way, the pole 5 is moved into a position that extends upwardly from the bladder surface, by virtue of the orthogonal orientation of the pole with respect to the base. The base may be made from rubber or a similar flexible or semi-flexible material, or may be rigid.

If desired, the mount 6 could be incorporated directly into or onto the outer surface of the inflatable bladder. However, to enable replacement of the light, or to allow the light to be retro-fitted to a life vest not already having a light according to embodiments of the present invention, the mount 6 can be provided with a strap or belt. The belt 8 may permanently or removably attached to the base 7, or may be integrally formed with the base 7. The belt 8 is configured to pass around the inflatable bladder of the life vest. It has a length such that when the bladder is inflated, the belt 8 fits closely around the bladder so that the base 7 is held flat against the bladder surface to elevate the pole 5, but not so closely that inflation of the bladder is restricted. For a typical size of life vest bladder, a belt length of about 400 mm may be suitable.

In the example of FIG. 1, the belt 8 is in two parts, 8a and 8b, that extend from either side of the base 6 in the manner of a wrist-watch strap. The two free ends of the belt 8 are fastenable together to form a loop around the bladder. A fastener such as a press stud, a hook-and-loop fastener, or a buckle can be provided to secure the free ends together. Non-corrosive materials are preferred for the fastener, such as plastic. Alternatively, the belt may form a continuous loop that can be passed over the end of a bladder which is configured as a U-shape or horse-shoe shape.

The light source 2 is powered by a power source included within the life vest, for example in the form of a battery. The battery and its connection to the light source 2 are sealed against water. To operate the light source 2, the battery is connected to the light source 2 via a water-activated switch. The switch has contacts exposed externally from the water-tight sealing or housing; these are configured to close the switch when the switch comes into contact with water. Hence, the light source is switched on automatically when the wearer enters water and the switch becomes wet.

The battery may be housed within the mount 6. The connection to the light source is disposed within the resilient pole 5. However, in the example of FIG. 1, the battery is housed in separate housing or power unit 9, electrically connected by a cable 10 to the base 7, where further connection is made through the pole 5 to the light source 2.

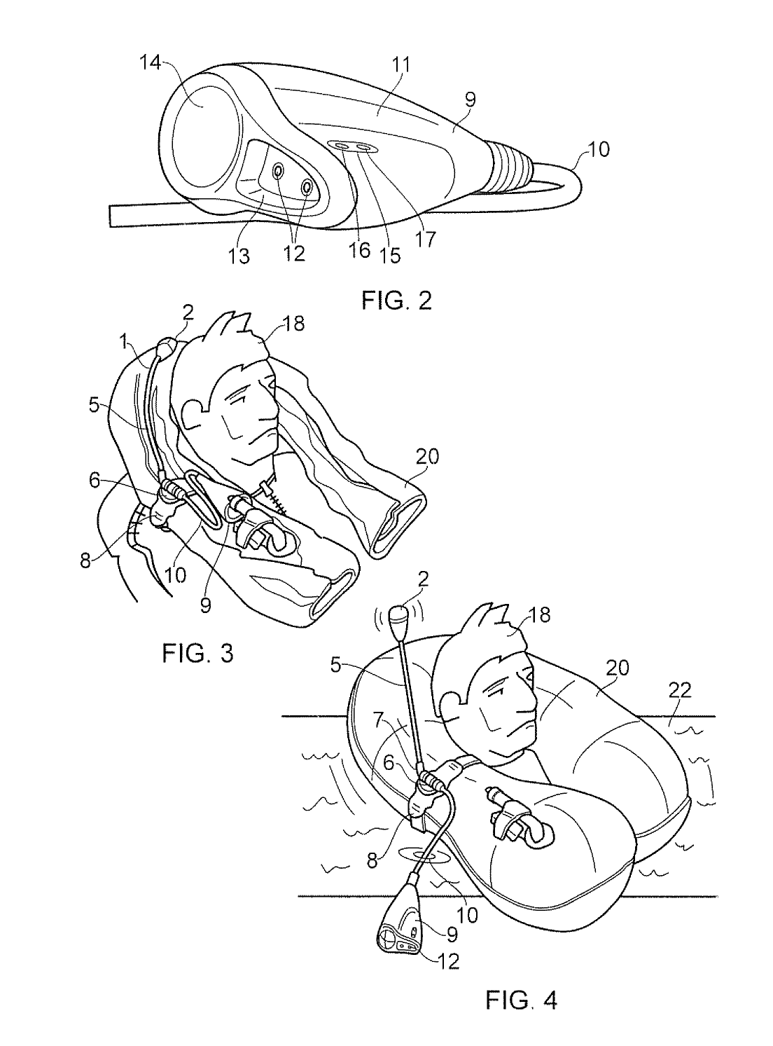

FIG. 2 shows an example of the power unit 9 in more detail. A sealed moulded housing 11 contains the battery in a water-tight manner. The water-activated switch is also disposed inside the housing 11. The contacts 12 for the switch are provided on the outside of the housing 11, in a recess 13 which helps to protect the contacts from accidental activation by, for example, a touch from wet hands. The cable 10 connects the power unit 9 to the mount 6. A power unit 9 disposed remotely from the rest of the light in this way allows better contact with water for activation of the switch, since the power unit can hang downwardly from the light and the inflated bladder into the water.

The cable 10 also allows ease of access to the power unit 9 for a user. This is advantageous for a power unit 9 configured according to the following further embodiment.

In this further embodiment, an example of which is illustrated in FIG. 2, the power unit 9 is provided with a battery test circuit. A manual test switch 14 is arranged inside the housing 11 in a water-tight manner such that it can be operated through the housing, for example via a flexible region of moulding. The test switch connects to a test circuit (not shown) that measures the level of electrical power remaining in the battery. A power level indicator 15 that responds to the power level measurement is provided within the housing 11. In this example, the indicator 15 comprises a pair of light emitting diodes 16, 17 that are visible through a transparent or translucent region of the housing 11. A diode 17 of a first colour, for example green, is illuminated if the power level measurement determines that the battery holds sufficient power for operating the light source 2. A diode 16 of a second colour, for example red, is illuminated if the power level measurement determines that the battery does not have enough power to operate the light source 2 for enough time to be useful. In this way, it is possible to test the power level available from the battery, and only replace the light when it is positively determined that the battery power is inadequate for safety purposes. This is preferable to existing arrangements in which safety is assured by replacing light sources periodically “just in case”, without any knowledge of whether such replacement is really necessary.

The indicator arrangement of FIG. 2, comprising a pair of differently coloured LEDs, is merely one example. Other arrangements are envisaged, such as: a single LED that illuminates only if there is adequate power for safe usage; a single LED that illuminates only if there is insufficient power for safe usage; a pair of same-coloured LEDs positioned next to two signs representing safe and unsafe usage in words, symbols or pictures; an LCD display depicting safe or unsafe usage in words, symbols or pictures; or an audible alarm or alert sound representing either safe or unsafe usage. Other alternatives will be apparent to the skilled person. However, arrangements in which both the “safe, adequate power” level and the “unsafe, inadequate power” level can be definitely signalled to the user may be preferred as leaving less doubt about whether the test has operated properly.

FIG. 3 shows an illustration of an individual 18 wearing a life vest with an undeployed inflatable bladder that is provided with a light such as that in the example of FIG. 1. The bladder 20 is uninflated and folded up, and in reality will be packed inside a protective cover (not shown) to which it is attached. The cover is in turn attached to a harness or other fastening or securing arrangement (not shown) which the wearer fastens or fits around his upper body when donning the life vest. The light 1 is also packed inside the cover, and is secured around the bladder 20 by means of the belt 8. The power unit 9 is packed next to the mount 6, with the power cable 10 coiled up. The resilient nature of the pole 5 allows the pole 5 and the light source 2 to be readily packed inside the cover because the pole can be curved around as necessary to follow the curved shape of those parts of the bladder and the cover that are intended to pass over the wearer's shoulder and/or behind the neck. Also there is little risk of the pole 5 being damaged when the life vest is stored or moved around because the pole 5 is able to bend and flex thereby avoiding accidental breakage.

FIG. 4 shows an illustration of the life vest and individual 18 after the individual has entered water 22 so that the bladder 20 has automatically inflated. The inflation expands the bladder 20 so that it fills the space within the belt 8, thereby positioning the mount 6 so that the planar base 7 lies against the upper surface of the bladder 20. The pole, released from its curved position inside the cover, resumes its straight shape. Because it is arranged substantially orthogonally on the mount 6, it extends up from the bladder, and lifts the light source 2 into an elevated location higher that the individual's head where it can more easily be seen. The power unit 9, meanwhile, is also released from the cover and is able to dangle from the power cable 10 down into the water 22 so that the water-sensitive switch contacts 12 become wet and automatically turn on the light source 2.

The pole 5 is shown in FIGS. 1 and 4 as being straight when the light is deployed. However, the pole may be configured to have a default curvature as this may aid in packing the light into the life vest cover. A curved pole of an adequate length will still achieve the desired effect of elevating the light source.

While the example life vest light described thus far and depicted in the FIGS. 1-4 includes both a pole for elevating the light source and a battery power test circuit, it is to be understood that these features can be employed separately according to various embodiments of the invention. Hence, a light can comprise a light source mounted on a resilient pole that is in turn mounted onto a mount such that the light source is elevated on inflation of a life vest bladder, without any means for testing a power source of the light being included. Similarly, a light for a life vest can comprise a light source powered by a battery and provided with a circuit for testing the power level of the battery, without the light source being mounted on a pole for elevation.

According to further embodiments, any of the above arrangements may include the additional feature of a sound source. The sound source is configured to emit an alarm sound in the event of the life vest being deployed, with the aim of further attracting the attention of rescuers.

FIG. 5 shows an example embodiment of a light that also incorporates a sound source. The Figure shows the upper part of a light 1 with a light source 2 mounted on a pole 5, similar to that shown in FIG. 1. The sound is emitted from a sound source comprising a loud speaker 30 located in the watertight housing 3 mounted on the upper end 5a of the pole 5. The loud speaker is protected by a waterproof cover or membrane to prevent the ingress of water. While a position for the loud speaker 30 at or near the upper end of the pole is preferred to enhance the broadcast of the emitted alarm sound over as large an area as possible, it may be located anywhere on the pole as preferred.

The sound is generated by an audio signal generator whose output is a sound signal which is sent to the loud speaker 30. The signal generator may be housed in a waterproof manner in any convenient location within the components already required for the light source. For example, in an embodiment such as that of FIG. 1, the signal generator can be housed inside the power unit 9, and connected to the loud speaker 30 by connections within the cable 10 and the pole 5. However, the signal generator could be located elsewhere if required, such as in the base 6.

The signal generator can generate a continuous tone, an intermittent tone, a constant tone, a varying tone, white noise, or any combination of these. For example, an intermittent tone can be particularly useful for attracting attention, while a source of white noise is more easily able to be located by a listener. Hence, a combination of these options may be beneficial.

The signal generator and the loud speaker 30 are conveniently powered by the battery that powers the light source 2. Also, the signal generator may be connected in the same circuit as the light source, so it is automatically activated to emit sound when the switch contacts 12 enter water. However, a constant emission of sound may be undesirable for the wearer of the life vest, so advantageously, the signal generator is connected to a manually activated switch so that the wearer can activate the sound at will.

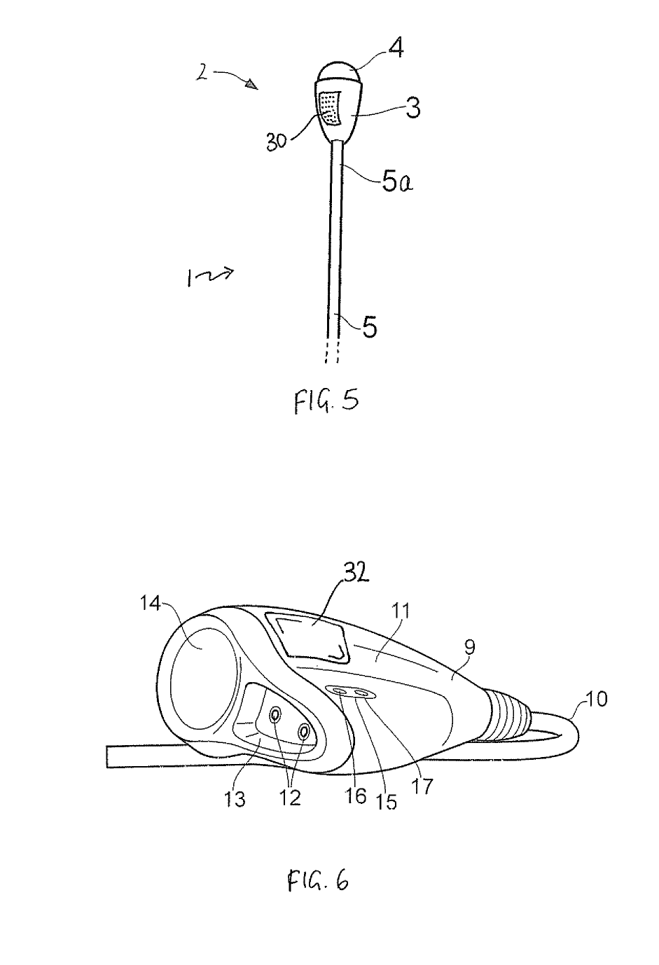

FIG. 6 shows an example of a power unit 9 configured with such a switch. The components of the power unit 9 are the same as those shown in FIG. 2, with the addition of a switch 32 for turning the sound on and off. In this example, the switch 32 is a push-button switch arranged inside the housing 11 in a water-tight manner so that it can be operated through the housing via a flexible portion of moulding. Other switch configurations are also possible, such as a slider switch. Any switch that can be made water-proof and which can be easily operated by an individual in water, who may be cold and/or fatigued, can be used. Locating the switch on the power unit 9 that depends from the cable 10 will likely make the switch easier for the wearer to access; however, other switch positions, such as on the pole 5 or the base 6, are possible.

A sound source for emitting an alarm sound can be incorporated into a light according to any of the previously described embodiments. Thus, a light may comprise a light source on a resilient pole where inflation of the light vest elevates the pole, plus a sound source, either with or without a power source test circuit. Alternatively, the light may include a light source and a sound source with or without a power source test circuit, and without an elevating pole. Further, the sound source may be deployed on a elevating pole without a light source, either with or without a power source test circuit.

1. A light for a life vest comprising:
a resilient pole;
a light source disposed at a first end of the resilient pole; and
a mount supporting a second end of the resilient pole, the mount configured for securing the light to an inflatable bladder of a life vest such that inflation of the bladder causes the pole to extend outwardly with respect to the surface of the bladder.

2. A light according to claim 1, in which the mount comprises a planar base from which the pole extends substantially orthogonally.

3. A light according to claim 2, in which the mount further comprises a belt attached to the base, the belt being configured to pass around an inflatable bladder of a life vest.

4. A light according to claim 3, in which the belt comprises a fastener by which the belt can be secured around an inflatable bladder of a life vest.

5. A light according to claim 4, in which the fastener is a press stud or a hook-and-loop fastening.

6. A light according to claim 1, in which the light source comprises one or more light emitting diodes.

7. A light according to claim 1, further comprising:
a power source operable to supply electrical power to the light source to illuminate the light source; and
a switch operable to connect the power source to the light source when the switch comes into contact with water.

8. A light according to claim 7, further comprising a power source test circuit operable to indicate an operating state of the power source to a user.

9. A light according to claim 8, in which the power source test circuit comprises:
a test switch actuable by a user to produce a measurement of a level of electrical power available from the power source; and
one or more indicators operable to notify a result of the electrical power level measurement to the user.

10. A light according to claim 9, in which the one or more indicators comprise a first indicator that notifies if the power source is able to supply adequate electrical power to illuminate the light source, and a second indicator that notifies if the power source is not able to supply adequate electrical power to illuminate the light source.

11. A light according to claim 9, in which the one or more indicators comprise one or more light emitting diodes.

12. A light according to claim 1, and further comprising a sound source operable to emit an alarm sound.

13. A light according to claim 12, in which the sound source comprises a loud speaker disposed at the first end of the resilient pole, a signal generator operable to supply a sound signal to the loud speaker, and a switch for activating the signal generator.

14. A light according to claim 13, in which the switch is a manually operated switch.

15. A life vest comprising an inflatable bladder and a light according to claim 1.

16. A light for a life vest comprising:
a light source attachable to an inflatable bladder in a life vest;
a power source operable to supply electrical power to the light source to illuminate the light source;
a switch operable to connect the power source to the light source when the switch comes into contact with water; and
a power source test circuit operable to indicate an operating state of the power source to a user.

17. A light according to claim 13, in which the power source test circuit comprises:
a test switch actuable by a user to produce a measurement of a level of electrical power available from the power source; and
one or more indicators operable to notify a result of the electrical power level measurement to the user.

18. A light according to claim 14, in which the one or more indicators comprise a first indicator that notifies if the power source is able to supply adequate electrical power to illuminate the light source, and a second indicator that notifies if the power source is not able to supply adequate electrical power to illuminate the light source.

19. A light according to claim 14, in which the one or more indicators comprise one or more light emitting diodes.

20. An audio alarm for a life vest, comprising: a resilient pole; a sound source operable to emit an alarm sound disposed at a first end of the resilient pole; and a mount supporting a second end of the resilient pole, the mount configured for securing the audio alarm to an inflatable bladder of a life vest such that inflation of the bladder causes the pole to extend outwardly with respect to the surface of the bladder.

21. An audio alarm according to claim 20, in which the sound source comprises a loud speaker disposed at the first end of the resilient pole, a signal generator operable to supply a sound signal to the loud speaker, and a switch for activating the signal generator.

22. An audio alarm according to claim 21, in which the switch is a manually operated switch.
